(19) United States
(12) Patent Application Publication
(10) Pub. No.: US 2012/0002975 A1
(43) Pub. Date: Jan. 5, 2012

(54) WIRELESS MICROPHONE

(75) Inventors: Yukihiro Nakazawa, Fukuoka (JP); Tetsuo Itou, Kanagawa (JP); Yuuji Kawasaki, Fukuoka (JP); Keiji Yamahai, Fukuoka (JP); Akira Okutani, Kanagawa (JP)

(73) Assignee: PANASONIC CORPORATION, Osaka (JP)

(21) Appl. No.: 13/255,403

(22) PCT Filed: Mar. 2, 2010
(86) PCT No.: PCT/JP2010/001396

§ 371 Date: Sep. 8, 2011

(30) Foreign Application Priority Data
Apr. 8, 2009 (JP) 2009-094193

(51) Int. Cl. H04B 10/04

(52) U.S. Cl. 398/132

(57) ABSTRACT

A wireless microphone transmits audio signals using infrared rays. A plurality of infrared light emitting devices are attached to a board in the wireless microphone, and at least one of the plurality of infrared light emitting devices is disposed on each side of the board. A plurality of infrared light emitting devices may be provided on each side of the board, and the infrared light emitting devices may be disposed radially. Without providing a different dedicated board for the light emitting devices than the board, infrared rays can be radiated to an area around the mic. In this manner, a wireless microphone is provided that can radiate infrared rays to an area around the mic and that has a simple structure and a small number of components and thus can improve productivity.

### TECHNICAL FIELD

The present invention relates to a wireless microphone that transmits audio signals using infrared rays.

### BACKGROUND ART

Conventionally, an infrared type wireless microphone (hereinafter, referred to as a mic) has a tubular case carried by a user, and infrared light emitting devices are included in the case. The infrared light emitting devices are generally light-emitting diodes (LEDs).

To receive a signal from the mic regardless of the directions of the user and mic, infrared rays need to be radiated in all directions, i.e., 360 degree directions. Hence, conventionally, a plurality of light-emitting diodes are mounted on a round board, and furthermore, the leg portions of the light-emitting diodes are bent. By this, the plurality of light-emitting diodes are disposed circularly such that each light-emitting diode faces outward. The round board is accommodated in the tubular case.

In order to avoid the light-emitting diodes from protruding outward from the round board as a result of the light-emitting diodes being simply bent outward, there is also proposed a process of bending the light-emitting diodes in a circumferential direction (for example, Patent Document 1).

However, in a conventional infrared type mic, as described above, a round board needs to be provided and the structure is complex and the number of components is large, and thus, there is a problem of low productivity.

Regarding this point, the mic needs to accommodate aboard having a microcomputer, an audio signal processing circuit, etc., placed thereon. To secure a required area by effectively utilizing elongated space in a mic housing, the board for a microcomputer, etc., is disposed such that the board sides are placed along an axial direction of the mic. In contrast to this, the round board for light-emitting diodes is disposed perpendicularly to the axial direction of the mic for omnidirectional irradiation. Therefore, the round board for light-emitting diodes needs to be provided separately from the board for a microcomputer, etc., and furthermore, a cable and a connector that connect the boards are required. Hence, the structure is complex and the number of components is large, and moreover, the number of board mounting steps increases and the number of man-hours needed for assembly also increases, resulting in low productivity.

### PRIOR ART DOCUMENTS

### Patent Documents

Patent Document 1: Japanese Patent Application Laid-Open No. 9-51279

### SUMMARY OF THE INVENTION

### Problems to be Solved by the Invention

The present invention is made under the above-described background. An object of the present invention is to provide a wireless microphone that can radiate infrared rays to an area around the mic and that has a simple structure and a small number of components and thus can improve productivity.

### Means for Solving the Problems

One aspect of the present invention is directed to a wireless microphone. The wireless microphone is a wireless microphone that transmits audio signals using infrared rays, wherein a plurality of infrared light emitting devices are attached to a board in the wireless microphone, and at least one of the plurality of infrared light emitting devices is disposed on each side of the board.

As will be described below, the present invention has other aspects. Therefore, the disclosure of the invention is intended to provide some aspects of the present invention and is not intended to limit the scope of the invention described and claimed herein.

### BRIEF DESCRIPTION OF THE DRAWINGS

FIG. 1 is an exploded perspective view of a mic according to an embodiment of the present invention.

FIG. 2 is a perspective view of an external appearance of the mic according to the embodiment of the present invention.

FIG. 3 is an exploded perspective view of a portion of a board around infrared light emitting devices.

FIG. 4 is a diagram of the infrared light emitting devices attached to the board, as viewed in an axial direction of a body case.

FIG. 5 is a diagram of the infrared light emitting devices attached to the board, as viewed in a lateral direction.

FIG. 6 is a front view of an upper half portion of the mic, showing an area around a portion where the infrared light emitting devices are provided.

FIG. 7 is a cross-sectional view of the mic cut along a line passing through the infrared light emitting devices on both sides of the board.

FIG. 8 is a diagram showing a first variant for the number and angle of infrared light emitting devices and showing the case where the number of devices is 8.

FIG. 9 is a diagram showing a second variant for the number and angle of infrared light emitting devices and showing the case where the number of devices is 4.

FIG. 10 is a diagram showing a third variant for the number and angle of infrared light emitting devices and showing the case where the number of devices is 2.

FIG. 11 is a diagram showing a variant for the attachment angle of infrared light emitting devices and showing a configuration in which each infrared light emitting device is disposed to be oriented to an elevation angle direction.

FIG. 12 is a diagram showing a variant in which a visible light emitting device is disposed on a guide member.

FIG. 13 is a diagram showing the variant in which the visible light emitting device is disposed on the guide member.

FIG. 14 is a diagram showing a variant in which a light emitting device holding portion is provided on each guide member.

FIG. 15 is a diagram showing the variant in which the light emitting device holding portion is provided on each guide member.

### MODE FOR CARRYING OUT THE INVENTION

A detailed description of the present invention will be made below. Note that the following detailed description and the accompanying drawings are not intended to limit the invention. Instead, the scope of the invention is defined by the appended claims.

The present invention is directed to a wireless microphone that transmits audio signals using infrared rays, and a plurality of infrared light emitting devices are attached to a board in the wireless microphone, and at least one of the plurality of infrared light emitting devices is disposed on each side of the board.

By this configuration, since, by providing infrared light emitting devices on both sides of the board in the wireless microphone, infrared rays can be radiated to an area around the mic, a board provided with infrared light emitting devices does not need to be specially provided and thus a cable or a connector between the boards is not required, either. Accordingly, the structure of the wireless microphone can be simplified and the number of components can be reduced and thus productivity can be improved.

In addition, in the wireless microphone according to the present invention, a plurality of infrared light emitting devices may be provided on each side of the board, and the infrared light emitting devices on both board sides may be disposed radially.

By this configuration, infrared rays can be appropriately radiated in all directions around the wireless microphone and thus an excellent directional pattern is obtained.

In addition, in the wireless microphone of the present invention, a number of the infrared light emitting devices may be set according to directivities of the infrared light emitting devices such that a radiation range covers all directions, and the plurality of infrared light emitting devices may be disposed to be spaced from each other in a circumferential direction.

By this configuration, infrared rays can be appropriately radiated in all directions around the wireless microphone and thus an excellent directional pattern is obtained.

In addition, the wireless microphone of the present invention may comprise a reflecting wall extending between adjacent infrared light emitting devices and reflecting infrared rays from the infrared light emitting devices on both sides.

By this configuration, by utilizing reflection of infrared rays by the reflecting walls, infrared rays are radiated in a circumferential direction of the wireless microphone and thus the radiation efficiency can be increased and an excellent directional pattern is obtained.

In addition, in the wireless microphone of the present invention, the infrared light emitting devices disposed on one side of the board and the infrared light emitting devices disposed on an other side may be offset in a direction along the board surface.

By this configuration, the infrared light emitting devices can be suitably attached to both sides of the board such that infrared rays can be radiated to an area around the wireless microphone.

In addition, in the wireless microphone of the present invention, the infrared light emitting devices may be attached so as to be inclined with respect to the board such that each infrared light emitting device is oriented to an elevation angle direction in a mic position taken when the mic is used.

By this configuration, the radiation directions of infrared rays from the wireless microphone can be oriented to infrared photoreceiver portions attached to a ceiling or an upper portion of a wall surface, and thus, the light receiving characteristics of the infrared photoreceiver portions can be improved.

In addition, in the wireless microphone of the present invention, a guide member may be attached to each side of the board, and the infrared light emitting devices may be attached to the board with the infrared light emitting devices disposed on their corresponding guide members, each guide member regulating positions and directions of corresponding infrared light emitting devices.

By this configuration, the infrared light emitting devices can be appropriately positioned and thus variations in the radiation direction of infrared rays can be kept small, enabling to further stabilize the infrared receiving characteristics.

In addition, in the wireless microphone of the present invention, a visible light emitting device may be disposed on the guide members, and the visible light emitting device may emit visible light through an infrared pass-through member provided around the infrared light emitting devices.

By this configuration, by allowing the visible light emitting device to emit light, a user is allowed to visually grasp the operating state of the wireless microphone. Such a visible light emitting device can be suitably attached by utilizing a structure for providing the infrared light emitting devices.

In addition, in the wireless microphone of the present invention, each of the guide members may have a guide base portion attached to the board; and a light emitting device holding portion connected to the guide base portion by an elastic hinge, and the light emitting device holding portion may have a structure that the light emitting device holding portion pivots via the elastic hinge to hold corresponding infrared light emitting devices.

By this configuration, since the infrared light emitting devices are held using the light emitting device holding members, attachment work of the infrared light emitting devices to the board is facilitated. For example, dropping off of the devices can be prevented when the board is inverted to solder the infrared light emitting devices to both sides of the board, and thus, attachment work is facilitated.

In the present invention, by providing infrared light emitting devices on both sides of a board in a wireless microphone, infrared rays can be radiated to an area around the mic and the structure is simple and the number of components can be reduced and thus productivity can be improved.

A wireless microphone (hereinafter, referred to as a mic) of an embodiment of the present invention will be described below with reference to the drawings.

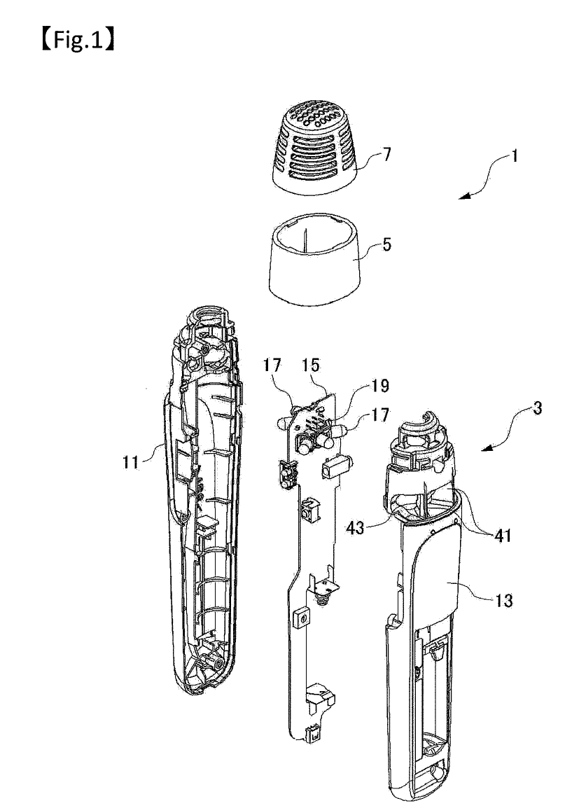

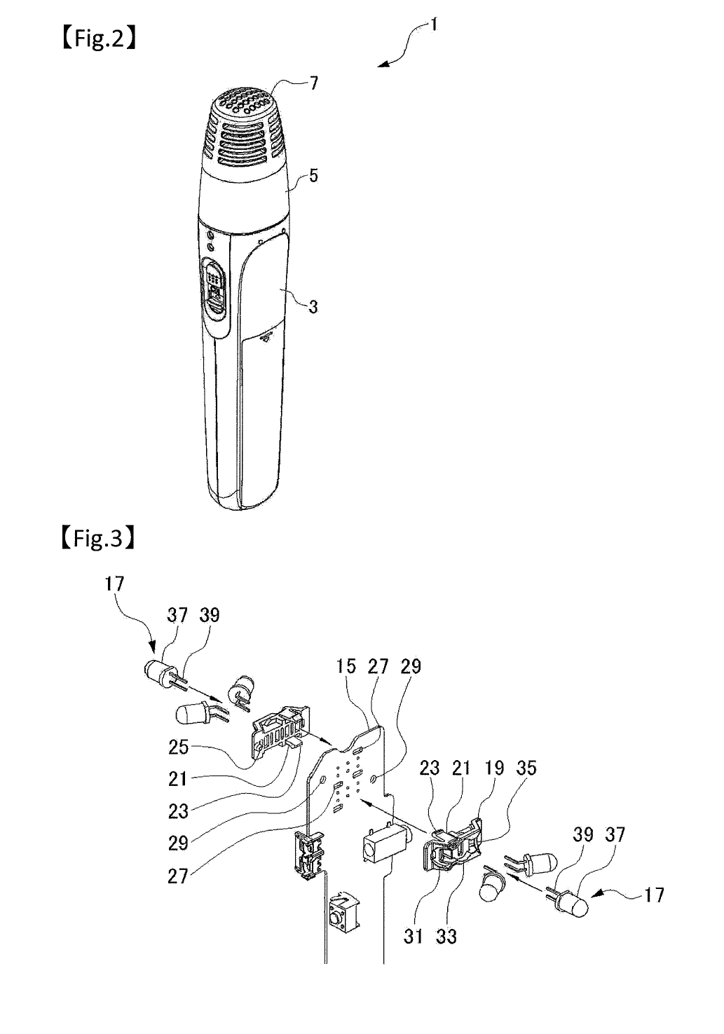

A mic according to an embodiment of the present invention is shown in FIGS. 1 and 2. FIG. 1 is an exploded perspective view of a mic 1 and FIG. 2 is a perspective view of an external appearance of the mic 1.

First, referring to FIG. 2, the mic 1 includes a tubular body case 3 serving as a mic case (housing); an infrared pass-through component 5 disposed at the top of the body case 3; and a mic net component 7 disposed at the top of the infrared pass-through component 5. The body case 3 has an exterior shape that is easy for a user to hold. Furthermore, the body case 3 is provided with a switch which is operated by the user with the user holding the mic 1, and is provided with a battery box.

Next, referring to FIG. 1, the body case 3 has a split structure and is composed of a right case 11 and a left case 13. The infrared pass-through component 5 is a collar type component that allows infrared rays to pass therethrough, and is fitted on the outer side of the body case 3. The mic net component 7 is, as shown in the drawing, a cap type component having a plurality of sound holes, and is disposed on the upper side of the infrared pass-through component 5 and covers the body case 3. A foam member for preventing breath blowing, wind noise upon operation, and water droplets is attached to the inner side of the mic net component 7.

A board 15 is housed inside the body case 3. The board 15 is disposed in the body case 3 to extend in an axial direction (tube direction), and the board surfaces are placed along the axial direction. The board 15 has a size close to the entire length of the space inside the case from a portion of the body case 3 near its lower end to a portion of the body case 3 near its upper end. In addition, though not shown, a mic component is attached to a tip portion of the body case 3. The mic component is, for example, an ECM (electret condenser microphone). The mic component is disposed on the inner side of the mic net component 7 and is connected to the board 15 by a cable.

The board 15 is a printed circuit board and has mounted thereon various components for allowing the mic 1 to function. For example, the board 15 has a microcomputer mounted thereon and also has an audio signal processing circuit mounted thereon.

In the present embodiment, as shown in the drawing, infrared light emitting devices 17 are attached to the board 15. The infrared light emitting devices 17 are disposed to be located on the inner side of the infrared pass-through component 5, and radiate infrared rays through the infrared pass-through component 5.

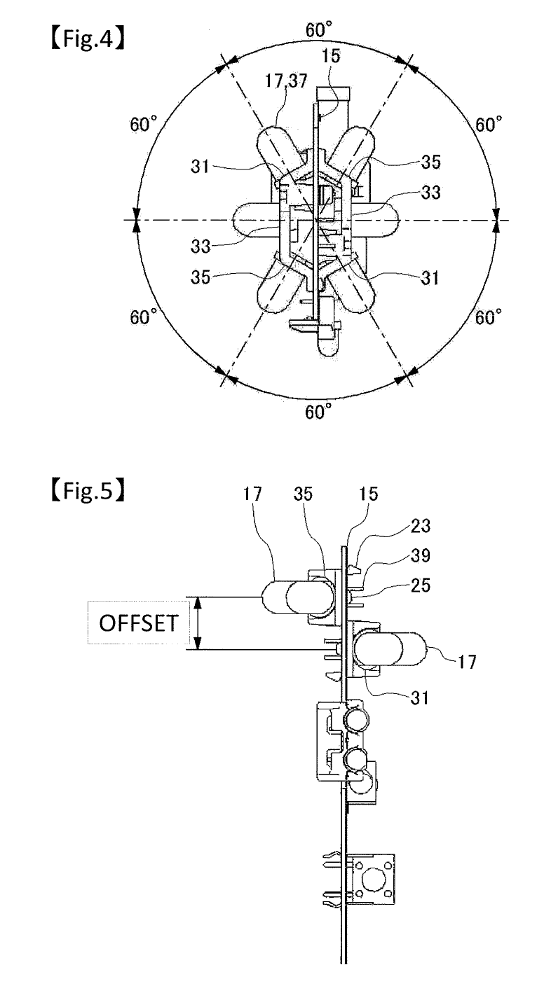

Referring to FIGS. 3 to 5, the configurations of those components related to the infrared light emitting devices 17 will be described. FIG. 3 is an exploded perspective view of a portion of the board 15 around the infrared light emitting devices 17. FIG. 4 is a diagram of the board 15 as viewed in the axial direction of the body case 3, and FIG. 5 is a diagram as viewed in a lateral direction. For a schematic configuration, guide members 19 are attached to both sides of the board 15, respectively. Three infrared light emitting devices 17 are supported on each guide member 19, by which three infrared light emitting devices 17 are disposed on each side of the board 15 and six infrared light emitting devices 17 in total are disposed. Those six infrared light emitting devices 17 are disposed such that adjacent infrared light emitting devices 17 form an angle of 60 degrees with each other. Therefore, those six infrared light emitting devices 17 are disposed to be spaced evenly around the 360 degrees in a circumferential direction. The configurations of those components related to the infrared light emitting devices 17 will be described in detail below.

The board 15 has a component side having components mounted thereon, and a solder side which is the back side of the component side. The two guide members 19 are attached to the component side and the solder side of the board 15, respectively. Each guide member 19 has a pair of leg portions 21 extending toward the board 15, and each leg portion 21 is provided with an engagement hook 23 at its tip. In addition, each guide member 19 has a pin 25 at a location distanced from the leg portions 21. By the engagement hooks 23 being engaged in rectangular holes 27 of the board 15, the guide members 19 are prevented from coming off, and by the pins 25 being inserted into round holes 29 of the board 15, the guide members 19 are prevented from rotating. By this, the guide members 19 are secured to the board 15.

The guide members 19 are configured to support the infrared light emitting devices 17 and regulate the positions and angles of the infrared light emitting devices 17. As shown in FIG. 4, each guide member 19 has three support portions 31, 33, and 35 so as to support three infrared light emitting devices 17, respectively. The support portion 33 at the center is parallel to the board 15 and is a predetermined distance away from the board 15. The support portions 31 and 35 on both sides are inclined 60 degrees with respect to the support portion 33 at the center.

Each of the support portions 31, 33, and 35 has a recess portion, and the bottom of each recess portion serves as a device placement surface (support surface). In addition, a wall surface of each recess portion has a cylindrical shape corresponding to the shape of an infrared light emitting device 17 (more specifically, a flange portion at the lower part of a device body). Each infrared light emitting device 17 is an infrared light-emitting diode (infrared LED), and has a cylindrical device body 37 made of resin and has two terminals 39 projecting from the underside of the device body 37. The device bodies 37 are inserted into the recess portions of their corresponding support portions 31, 33, and 35, and the undersides of the bodies are supported on the device placement surfaces at the bottoms of the recess portions. By this, the infrared light emitting devices 17 are positioned.

The terminals 39 of the infrared light emitting devices 17 project through holes provided in the support portions 31, 33, and 35, and penetrate through the board 15 and are soldered to the board 15 on the opposite side. For those infrared light emitting devices 17 on the left and right, their terminals 39 are subjected to a bending process in advance, by which the terminals 39 extend toward the board 15, penetrate through the board 15, and are soldered.

As described above, on each side of the board 15, the support portion 33 at the center of the guide member 19 is parallel to the board 15, and thus, the infrared light emitting device 17 at the center is oriented to a direction perpendicular to the board 15. Since the support portions 31 and 35 on both sides are inclined 60 degrees, the infrared light emitting devices 17 on both sides also form an angle of 60 degrees with the infrared light emitting device 17 at the center.

Therefore, on both sides of the board 15 as a whole, six infrared light emitting devices 17 are disposed to be spaced evenly at 60 degree intervals in an axial circumferential direction of the mic 1, and thus, can irradiate infrared rays in all directions, i.e., 360 degree directions. Such omnidirectional infrared radiation is implemented by mounting the infrared light emitting devices 17 on the board 15 having a microcomputer, a signal processing circuit, etc., placed thereon. Namely, omnidirectional infrared radiation is implemented without utilizing a round board which is a separate unit, as does in the conventional case.

In addition, in the present embodiment, each guide member 19 has, as described above, support portions 31, 33, and 35 serving as device placement surfaces, and thereby physically regulates the positions and directions of the infrared light emitting devices 17. By this, compared to a configuration in which the infrared light emitting devices 17 are directed by, for example, manually bending the terminals 39, variations in the optical axis direction of the infrared light emitting devices 17 are reduced, enabling to increase the stability of infrared receiving characteristics.

In addition, as shown in FIG. 5, on both sides of the board 15, the two guide members 19 are offset in an up and down direction, and the infrared light emitting devices 17 are also offset in the up and down direction. This configuration can avoid the two guide members 19 from being arranged back to back on both sides of the board 15 and can avoid the infrared light emitting devices 17 from being arranged at the same location in the axial direction. By this, the two guide members 19 can be suitably attached to the board 15 without interfering with each other. In addition, interference between the infrared light emitting devices 17 on both board sides can be avoided and soldering of the infrared light emitting devices 17 can also be appropriately performed.

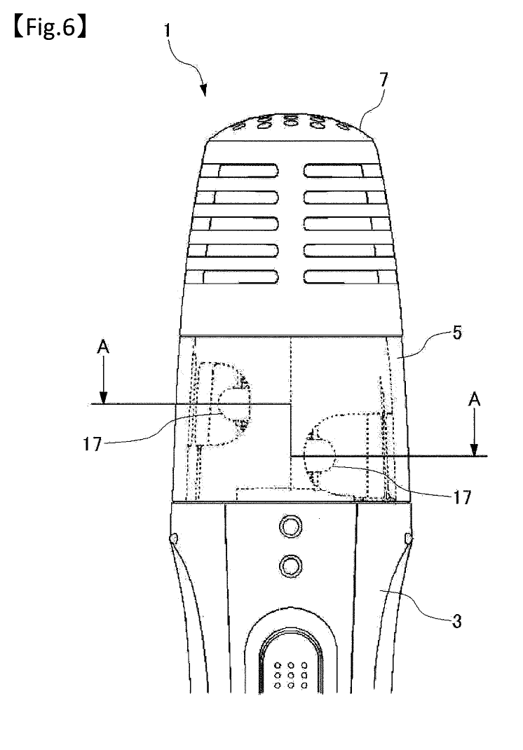

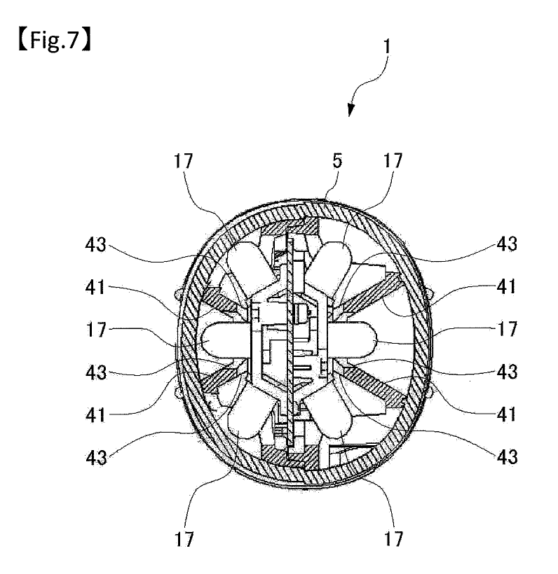

Next, referring to FIGS. 6 and 7, a structure of a portion of the body case 3 related to the infrared light emitting devices 17 will be described. FIG. 6 is a front view of the mic 1. FIG. 7 is a cross-sectional view taken along line A-A of FIG. 6, where the mic 1 is cut along a line passing through the infrared light emitting devices 17 on both sides of the board.

As shown in the drawing, the mic 1 has reflecting walls 41 each extending between adjacent infrared light emitting devices 17. On each side of the board 15, reflecting walls 41 are disposed on both sides of the infrared light emitting device 17 at the center. The reflecting walls 41 are colored with a color with high infrared reflectance such as silver or white.

The configuration of the reflecting walls 41 will be further described. As shown in FIG. 1, the reflecting walls 41 are a part of the body case 3. The body case 3 has openings 43 at the locations of the infrared light emitting devices 17. The openings 43 are windows for the infrared light emitting devices 17, and the infrared light emitting devices 17 are disposed in the openings 43. Each reflecting wall 41 acts as a column that connects a portion above the reflecting wall 41 to a portion below the reflecting wall 41.

Since the reflecting walls 41 are provided in the above-described manner, the following advantages are obtained. The reflecting walls 41 reflect infrared rays emitted from the infrared light emitting devices 17. Infrared rays from the infrared light emitting devices 17 not only travel in straight lines but are also reflected by the reflecting walls 41 and then pass through the infrared pass-through component 5. Accordingly, the efficiency of radiation to an area around the wireless microphone increases and thus the infrared intensity distribution can be made more uniform, enabling to further improve the directional pattern.

In addition, the reflecting walls 41 function as beams that prevent deformation of the body case 3. By this, for example, when an overload acts in the case where the mic 1 is stepped on, etc., or, for example, when an impact acts on the mic 1 in the case where the mic 1 is accidentally dropped, etc., the body case 3 and the infrared pass-through component 5 can be prevented from being broken.

Next, a method of manufacturing a mic 1 will be described. In the following, a method of manufacturing a portion related to the present invention will be mainly described. As shown in FIG. 3, two guide members 19 are attached to both sides of a board 15, respectively. When the guide members 19 are attached, engagement hooks 23 of the guide members 19 are aligned with rectangular holes 27 of the board 15, pins 25 are aligned with round holes 29, and then the guide members 19 are pressed against the board 15. By this, the engagement hooks 23 are engaged in the rectangular holes 27 and the pins 25 are inserted into the round holes 29.

Then, three infrared light emitting devices 17 are disposed on support portions 31, 33, and 35 of each guide member 19. Here, the infrared light emitting devices 17 are inserted into recess portions of the respective support portions 31, 33, and 35, and the undersides of device bodies 37 are allowed to abut on the support portions 31, 33, and 35. By this, terminals 39 penetrate through the board 15 and project from the opposite side. The terminals 39 of those infrared light emitting devices 17 on both sides are, as shown in FIG. 3, bent in advance. The terminals 39 of the three infrared light emitting devices 17 are soldered to the board 15. After the soldering, unnecessary portions of the terminals 39 are cut off. The above-described work is performed on each side of the board 15. By this, six infrared light emitting devices 17 are mounted on the board 15.

Next, a right case 11 and a left case 13 are combined with the board 15 sandwiched therebetween, thereby forming a body case 3. By this, six infrared light emitting devices 17 are disposed in six openings 43 of the body case 3. Furthermore, though not shown, a mic component such as an ECM is attached to the body case 3 and a cable for the mic component is connected to a connector of the board 15.

Furthermore, an infrared pass-through component 5 is fitted at the top of the body case 3, and a mic net component 7 is attached on the infrared pass-through component 5. In this manner, assembly of the mic 1 is completed.

The method of manufacturing the mic 1 according to the present embodiment is described above. Next, various variants of the present embodiment will be described.

“The number and disposition of infrared light emitting devices”

In the above-described embodiment, six infrared light emitting devices 17 are disposed at 60 degree intervals, by which an omni-, i.e., 360 degrees-, directional pattern is ensured. The directivity varies depending on the specifications of infrared light emitting devices. However, even when infrared light emitting devices with different directivities are applied, by appropriately setting the number of devices and device disposition (attachment angle), the directional pattern of the mic as a whole can be favorably set and thus infrared rays can be appropriately radiated to an area around the mic. Some examples with different numbers of devices and different device dispositions will be described below.

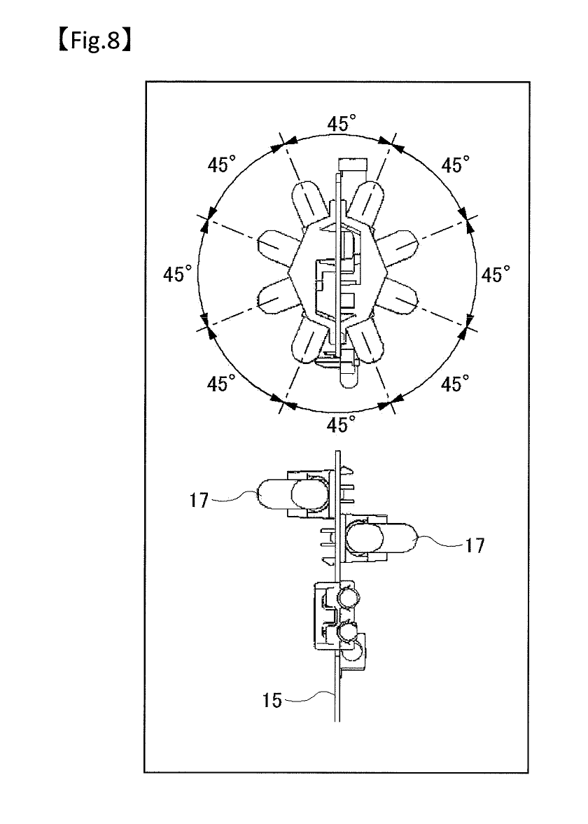

FIG. 8 shows a first example. In this example, the radiation range (directional angle) for each device is narrower than that for the infrared light emitting devices 17 of the above-described embodiment. Hence, the number of devices is set to 8 so as to cover all directions of 360 degrees, and four infrared light emitting devices 17 are disposed on each side of a board 15. The angle between devices is set to 45 degrees and eight infrared light emitting devices 17 are disposed to be spaced evenly in a circumferential direction.

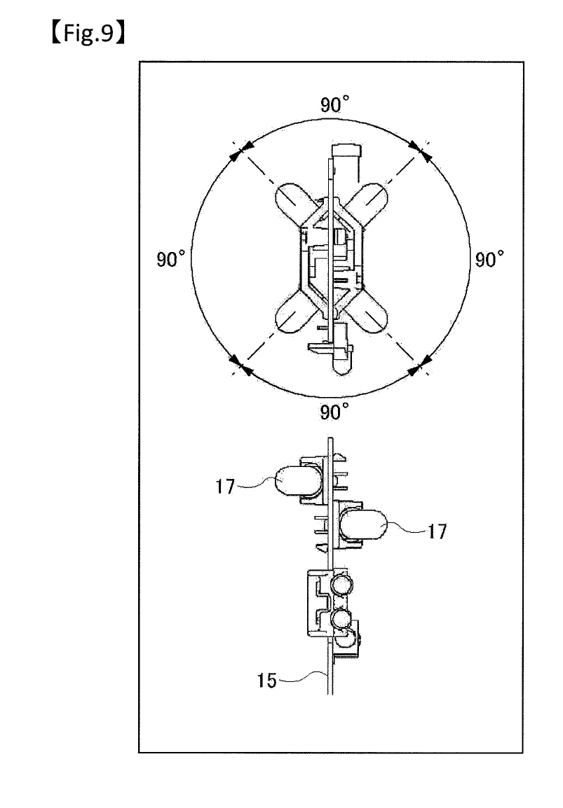

FIG. 9 shows a second example. In this example, the radiation range for each device is wider than that for the infrared light emitting devices 17 of the above-described embodiment. Hence, the number of devices is set to 4 and two infrared light emitting devices 17 are disposed on each side of a board 15. In addition, the angle between devices is set to 90 degrees.

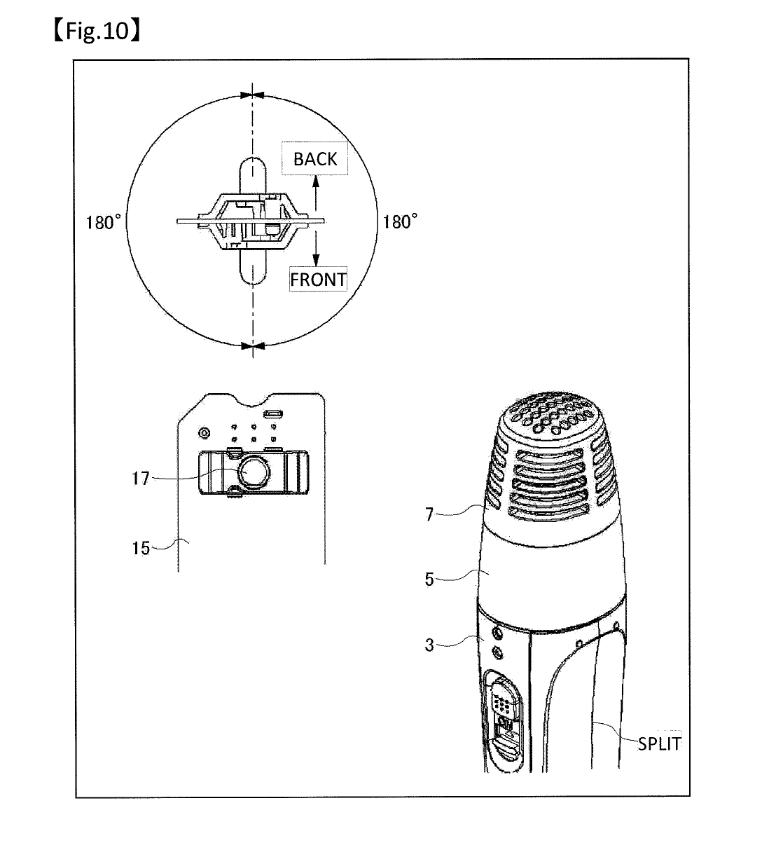

FIG. 10 shows a third example. In this example, the number of devices is 2 and one device is disposed on each side of a board 15, and the angle between the devices is 180 degrees. As shown in this example, in the scope of the present invention, a mic 1 may have at least one infrared light emitting device 17 on each side of the board 15. Note, however, that it is preferred to provide a greater number of infrared light emitting devices 17, and a wider and more uniform directional pattern is obtained.

The configuration in FIG. 10 differs in the orientation of the board 15 from that in the above-described embodiment, and this point will be described below.

A user normally holds the mic 1 such that his/her thumb is located on the switch on the exterior of the case. At this time, the switch is present on the front side to the user. Hence, in the following description, the switch side is referred to as the front side, the opposite side is referred to as the back side, a direction connecting the front to the back is referred to as the front and back direction, and a direction perpendicular to the front and back direction is referred to as the left and right direction.

In the above-described embodiment, both board sides of the board 15 are oriented to the left and right direction. In contrast to this, in the configuration in FIG. 10, the orientation of the board 15 is changed and both board surfaces are oriented to the front and back direction (the board surfaces are placed along the left and right direction). By this, the infrared light emitting devices 17 are disposed facing the front side and the back side. This configuration is advantageous in terms of the following aspects.

In FIG. 10, the infrared light emitting devices 17 having wide directivity are used, but even so, there is a limit to the directivity. Hence, when the number of devices is small as in the example of FIG. 10, the infrared reaching distance is longer in the optical axis direction of an infrared light emitting device 17 than in other directions. On the other hand, in many cases, a photosensor that receives infrared rays from the mic 1 is present in a user's front direction. Therefore, by using a board and device disposition such as those described above, infrared rays from the mic 1 can be more securely allowed to reach the photosensor.

In addition, although the above description assumes that the photosensor is present in the front direction of the mic 1, the photosensor may be located laterally to the mic 1. For example, a portable amplifier with a sensor, or the like, is portably placed on a user, and thus, a photosensor is often located laterally to the mic 1. However, in this case, since the photosensor is present near the user, even if the infrared light emitting devices 17 are oriented to the front and back direction as shown in FIG. 10, infrared rays can be suitably allowed to reach the photosensor.

In addition, in the aforementioned embodiment, a body case 3 is split in the left and right direction. In contrast to this, in the configuration in FIG. 10, a body case 3 is split in the front and back direction. By this, the board 15 oriented to the front and back direction can be suitably accommodated in the body case 3. In addition, openings (windows) for the infrared light emitting devices 17 oriented to the front and back direction are suitably provided in the body case 3.

Three examples with different numbers of devices and different device dispositions are described above. In addition to them, the number of devices may be an odd number within the scope of the present invention. In this case, it is preferred that odd-numbered devices be disposed to be spaced evenly as a whole in a circumferential direction.

“Attachment angle oriented to an elevation angle direction”

Next, a variant regarding the attachment angle in an up and down direction of infrared light emitting devices 17 will be described. In many cases, the tubular mic 1 according to the present embodiment is normally held by a user in a nearly vertical position. The vertical position is a position in which an axial direction of the mic 1 is oriented to a vertical direction and the tip faces upward.

In the above-described embodiment, since the optical axes of the infrared light emitting devices 17 are in a plane perpendicular to the board 15, when the mic 1 is in the vertical position, the optical axes of the infrared light emitting devices 17 are oriented to a horizontal direction. Infrared rays are radiated mainly in the horizontal direction and are radiated uniformly in an elevation angle direction and a depression angle direction. However, the optical axis directions largely deviate from the directions of infrared photoreceiver portions (photosensors) disposed on a ceiling and an upper portion of a wall surface, which causes a reduction in photosensitivity, and thus, is unfavorable to the light receiving characteristics. This variant is to improve the light receiving characteristics, taking into account the above-described point.

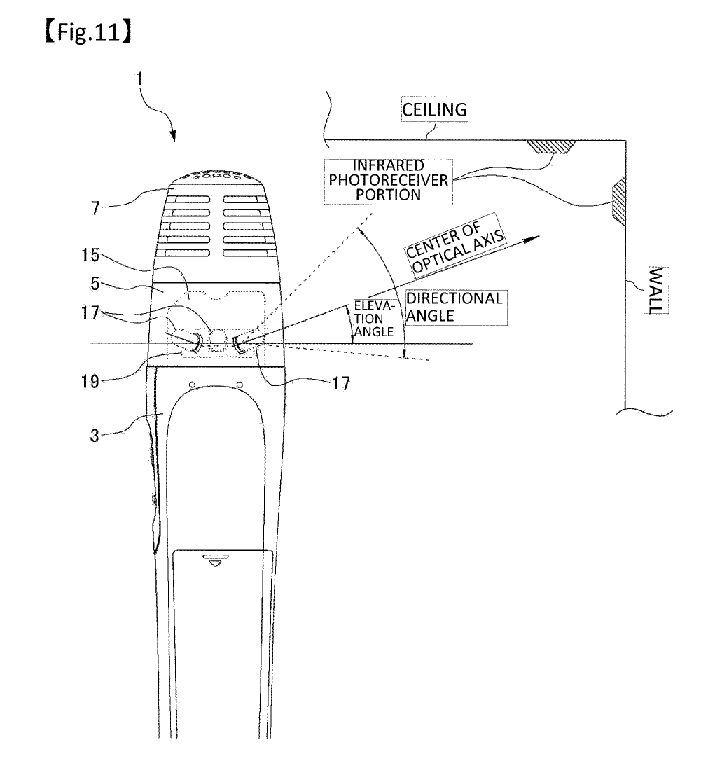

FIG. 11 shows a configuration of a mic 1 according to this variant. The mic 1 is in a vertical position taken when the mic 1 is used. Infrared photoreceiver portions (photosensors) are attached to a ceiling and an upper portion of a wall surface in order to avoid shields. In FIG. 11, for description's sake, the ceiling and the wall surface and the mic 1 have different size ratios.

As shown in FIG. 11, the attachment angle of infrared light emitting devices 17 is set such that each infrared light emitting device 17 is oriented to an elevation angle direction in a mic position taken when the mic is used. To implement this attachment angle, recess portions of support portions 31, 33, and 35 of each guide member 19 are inclined upward, by which device placement surfaces (the bottoms of the recess portions) are also inclined upward. Here, the “upward” refers to the direction of the tip of the mic 1. By this, the infrared light emitting devices 17 are attached to a board 15 in an inclined manner such that the optical axis of each infrared light emitting device 17 is oriented to an elevation angle direction.

As described above, by allowing each infrared light emitting device 17 to be oriented to an elevation angle direction, the deviation between an infrared axis and the directions of the infrared photoreceiver portions is reduced. As shown in the drawing, the infrared photoreceiver portions appropriately come within the range of the directional angle of the infrared light emitting device 17. Accordingly, the angle of the infrared axis can be optimized, enabling to improve the light receiving characteristics.

“Addition of a visible light emitting device”

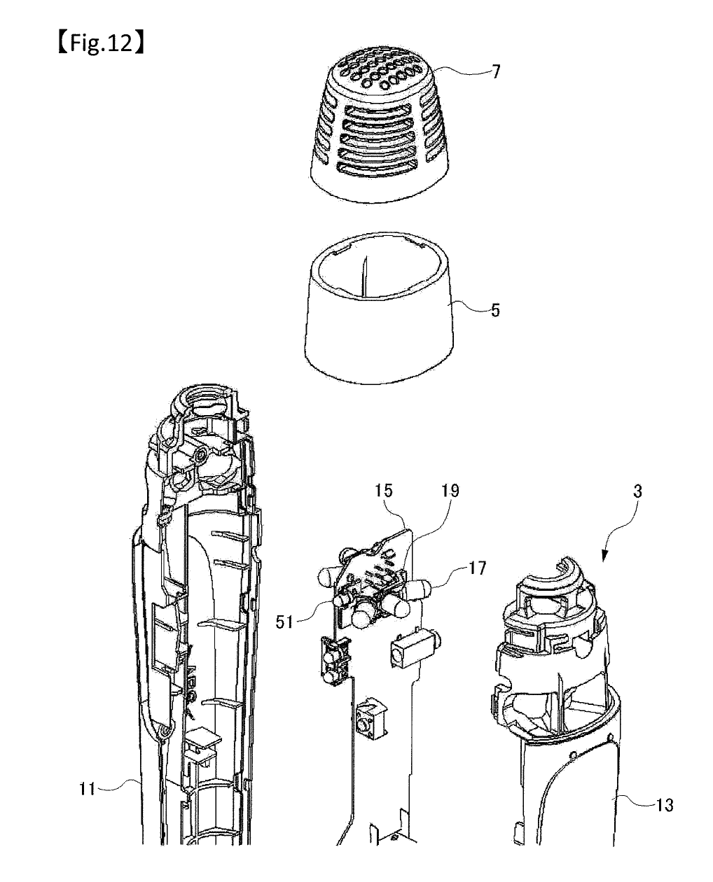

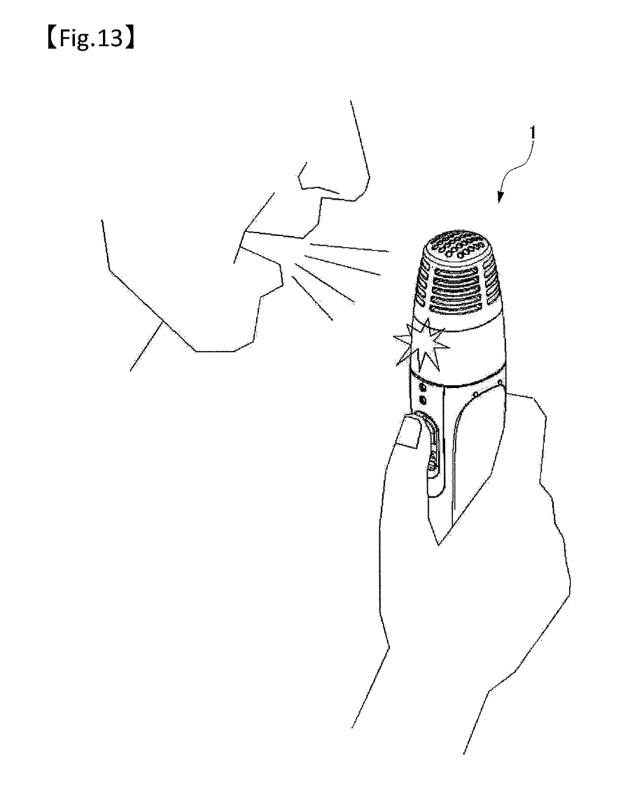

Referring to FIGS. 12 and 13, in this variant, a visible light emitting device 51 is added. A guide member 19 has a shape that guides the visible light emitting device 51, by which the visible light emitting device 51 is disposed at a predetermined location of the guide member 19 and terminals of the visible light emitting device 51 are soldered to a board 15.

Referring to FIG. 13, as already described, in many cases, a user holds a mic 1 such that his/her thumb is placed on a switch present on the front side. The visible light emitting device 51 is disposed on the same side as the switch, i.e., at a location close to the front of the mic 1, so as to face the front. The guide shape of the guide member 19 is configured to implement such a disposition.

The light up of the visible light emitting device 51 is controlled by a circuit such as a microcomputer on the board 15. The light up of the visible light emitting device 51 is controlled according to the operating state of the mic 1, and the visible light emitting device 51 lights up when the mic 1 is functioning normally. Specifically, in this variant, the visible light emitting device 51 lights up when an audio input is performed and infrared rays which are FM-modulated by audio signals are emitted from infrared light emitting devices 17. The visible light emitting device 51 may continuously light up or may blink.

Visible light from the visible light emitting device 51 passes through an infrared pass-through component 5. A user can grasp the operating state of the mic 1 by seeing the light up of the visible light emitting device 51 and can thereby confirm that the mic 1 is functioning normally. Note that the visibility of visible light may be increased by reducing the thickness of a visible light pass-through portion (a portion corresponding to the visible light emitting device 51) of the infrared pass-through component 5 or by providing a visible light pass-through member in that portion.

In this manner, in this variant, by utilizing a guide member 19 for attaching infrared light emitting devices 17, a visible light emitting device 51 can also be attached to the board 15. The visible light emitting device 51 can be provided with a simple structure and a user can grasp the operating state of the mic 1.

“Deformation of the guide members (addition of light emitting device holding portions)”

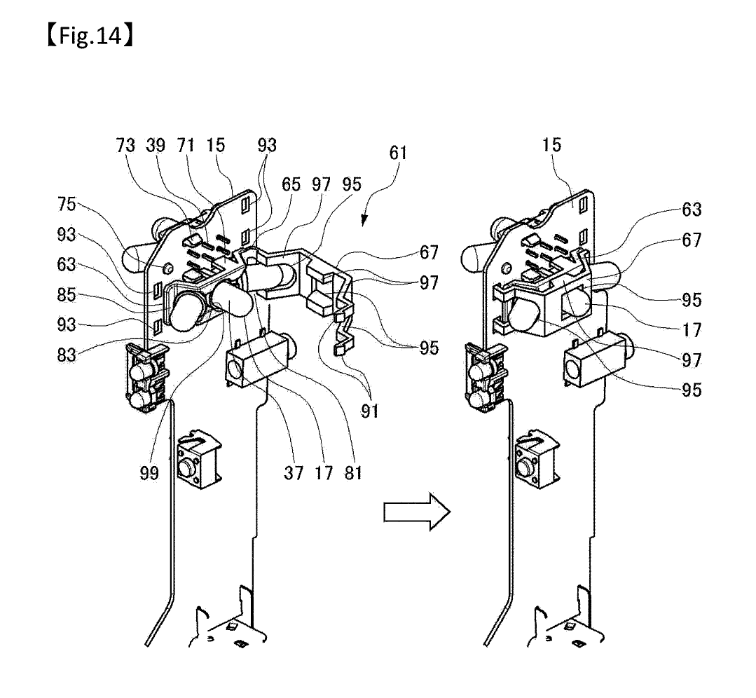

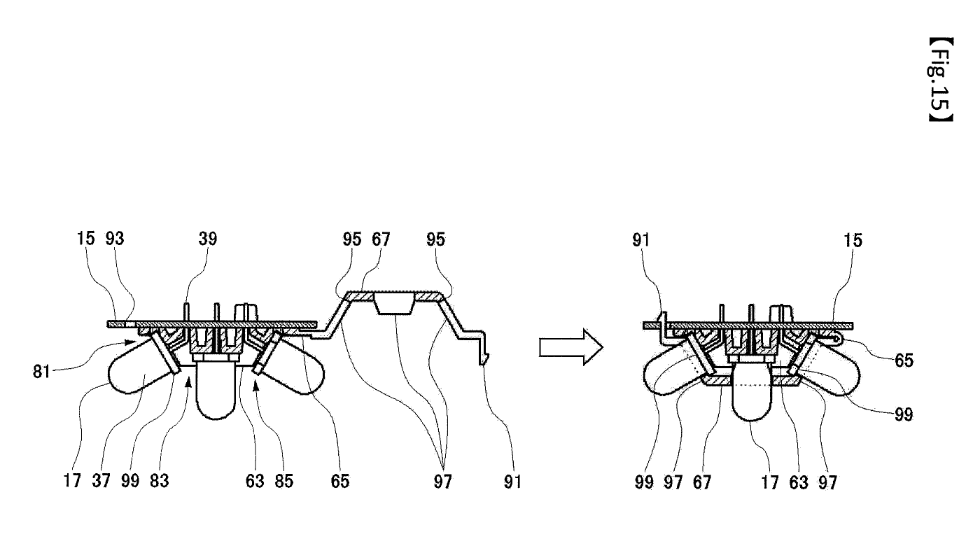

FIGS. 14 and 15 show still another variant of the present embodiment. In this variant, guide members that position infrared light emitting devices are deformed.

As shown in the drawings, in this variant, guide members 61 are attached to a board 15. Each guide member 61 is composed of a guide base portion 63, an elastic hinge 65, and a light emitting device holding portion 67. They are an integral member and the guide base portion 63 and the light emitting device holding portion 67 are connected by the elastic hinge 65. The elastic hinge 65 is a thin-walled portion, and the light emitting device holding portion 67 can be allowed to cover the guide base portion 63 by bending the guide member 61 at the elastic hinge 65.

The guide bases portion 63 are configured to perform the same function as the guide members 19 described in the aforementioned embodiment. Specifically, each guide base portion 63 has a pair of leg portions 71 and each leg portion 71 is provided with an engagement hook 73 at its tip. In addition, each guide base portion 63 has a pin 75 at a location distanced from the leg portions 71. By the engagement hooks 73 being engaged in rectangular holes of the board 15, the guide members 61 are prevented from coming off, and by the pins 75 being inserted into round holes of the board 15, the guide members 61 are prevented from rotating. By this, the guide members 61 are secured to the board 15.

Furthermore, each guide base portion 63 has support portions 81, 83, and 85, and the support portions 81, 83, and 85 support infrared light emitting devices 17, respectively. Each of the support portions 81, 83, and 85 has a recess portion. The infrared light emitting devices 17 are inserted into their corresponding recess portions, and device bodies 37 abut on device placement surfaces at the bottoms of the recess portions, whereby the infrared light emitting devices 17 are positioned. In addition, the support portion 83 at the center is parallel to the board 15, and the support portions 81 and 85 on both sides are inclined. By this, three infrared light emitting devices 17 are disposed to be oriented to directions differing by 60 degrees from each other.

The light emitting device holding portions 67 have a warp shape corresponding to the shape of the guide base portions 63. By this, when the guide member 61 is bent at the elastic hinge 65, the light emitting device holding portion 67 is located above the guide base portion 63 so as to cover the guide base portion 63.

Each light emitting device holding portion 67 is provided with engagement hooks 91 at its tip. The engagement hooks 91 are engaged in engagement holes 93 of the board 15, by which the light emitting device holding portion 67 is secured covering a corresponding guide base portion 63.

Each light emitting device holding portion 67 has, as shown in the drawings, window portions 95 at locations corresponding to three infrared light emitting devices 17. The infrared light emitting devices 17 are located in the window portions 95. The window portions 95 have a shape that does not hinder infrared radiation from the infrared light emitting devices 17.

Each light emitting device holding portion 67 further has abutment portions 97 that abut on the infrared light emitting devices 17. Each abutment portion 97 abuts on a flange portion 99 present at a bottom edge of the device body 37 of a corresponding infrared light emitting device 17. By this, the flange portion 99 is sandwiched between the guide base portion 63 and the light emitting device holding portion 67, and the infrared light emitting device 17 is held.

Next, a method of manufacturing a mic 1 for the case of using guide members 61 will be described. Here, a preferred example of the operation of attaching infrared light emitting devices 17 to a board 15 using guide members 61 will be described.

First, two guide members 61 are attached to both sides of a board 15, respectively. Here, in particular, guide base portions 63 of the guide members 61 are attached to the board 15. Specifically, the guide base portions 63 are disposed at predetermined locations of the board 15 and are then pressed against the board 15. By this, engagement hooks 73 of the guide base portions 63 are engaged in rectangular holes of the board 15 and pins 75 are inserted into round holes of the board 15.

Then, three infrared light emitting devices 17 are disposed on support portions 81, 83, and 85 of each guide base portion 63. Here, the infrared light emitting devices 17 are inserted into recess portions of the respective support portions 81, 83, and 85, and the undersides of device bodies 37 are allowed to abut on the support portions 81, 83, and 85. Terminals 39 of the infrared light emitting devices 17 penetrate through the board 15 and project from the opposite side.

Then, each guide member 61 is bent at an elastic hinge 65. Each light emitting device holding portion 67 pivots about a corresponding elastic hinge 65 and covers a corresponding guide base portion 63. Engagement hooks 91 at the tip of the light emitting device holding portion 67 are engaged in engagement holes 93 of the board 15. By this, abutment portions 97 of the light emitting device holding portion 67 abut on flange portions 99 of the device bodies 37 of the infrared light emitting devices 17, and the infrared light emitting devices 17 are held by the light emitting device holding portion 67.

Then, the terminals 39 of the three infrared light emitting devices 17 are soldered to the board 15. As shown in FIG. 15, the terminals 39 project from the board 15. Those portions are soldered and then unnecessary portions of the terminals 39 are cut off. In this variant, the infrared light emitting devices 17 are attached to both sides of the board 15 and thus the board 15 may be turned over for soldering work. Even in this case, since the infrared light emitting devices 17 are held by the light emitting device holding portions 67, the infrared light emitting devices 17 are prevented from dropping off, facilitating the work.

To prevent the infrared light emitting devices 17 from dropping off, a special jig may be considered to be used. However, cumbersome work such as attaching and removing of the jig arises. According to this variant, a light emitting device holding portion 67 is integrally provided to a guide member 61. Therefore, without increasing the number of components, the infrared light emitting devices 17 can be prevented from dropping off and the necessity for a jig can be eliminated.

Amic 1 (wireless microphone) according to the embodiment of the present invention is described above. According to the present embodiment, infrared rays can be radiated to an area around the mic by providing infrared light emitting devices 17 on both sides of a board 15 in the mic 1. Thus, a board dedicated to the infrared light emitting devices does not need to be provided separately from the board 15, and a cable or a connector between the boards is not required. Accordingly, the structure of the wireless microphone can be simplified and the number of components can be reduced and thus productivity can be improved.

In addition, in the present embodiment, a plurality of infrared light emitting devices are provided on each side of the board 15 and the infrared light emitting devices on both board sides are disposed radially. Accordingly, infrared rays can be appropriately radiated in all directions around the mic and thus an excellent directional pattern is obtained.

In addition, in the present embodiment, the number of infrared light emitting devices 17 is set according to the directivities of the infrared light emitting devices 17 such that the radiation range covers all directions, and the plurality of infrared light emitting devices 17 are disposed to be spaced from each other in a circumferential direction. Accordingly, infrared rays can be appropriately radiated in all directions around the mic and thus an excellent directional pattern is obtained.

In addition, in the present embodiment, a reflecting wall 41 is provided to extend between adjacent infrared light emitting devices 17, and reflects infrared rays from the infrared light emitting devices 17 on both sides. By utilizing reflection of infrared rays by the reflecting walls 41, variations in the radiation intensity of infrared rays can be reduced and thus an excellent directional pattern is obtained.

In addition, in the present embodiment, the infrared light emitting devices 17 disposed on one side of the board 15 and the infrared light emitting devices 17 disposed on the other side are offset in a direction along the board surface. Accordingly, the infrared light emitting devices 17 can be suitably attached to both sides of the board 15 such that infrared rays can be radiated to an area around the mic.

In addition, in the present embodiment, the infrared light emitting devices 17 are attached so as to be inclined with respect to the board 15 such that each infrared light emitting device 17 is oriented to an elevation angle direction in a mic position taken when the mic is used. Accordingly, the radiation directions of infrared rays from the mic 1 can be oriented to infrared photoreceiver portions attached to a ceiling and an upper portion of a wall surface, and thus, the light receiving characteristics of the infrared photoreceiver portions can be improved.

In addition, in the present embodiment, a guide member 19 that regulates the positions and directions of infrared light emitting devices 17 is attached to each side of the board 15, and the infrared light emitting devices 17 are attached to the board 15 with the infrared light emitting devices 17 disposed on the guide member 19. By this, the infrared light emitting devices 17 can be appropriately positioned and thus variations in the radiation direction of infrared rays can be kept small, enabling to further stabilize the infrared receiving characteristics.

In addition, in the present embodiment, a visible light emitting device 51 is disposed on the guide members 19, and the visible light emitting device 51 emits visible light through an infrared pass-through component 5 provided around the infrared light emitting devices 17. By this, by allowing the visible light emitting device 51 to emit light, a user is allowed to visually grasp the operating state of the mic 1. Such a visible light emitting device 51 is suitably attached by utilizing a structure for providing the infrared light emitting devices 17.

In addition, in the present embodiment, as shown in FIGS. 14 and 15, each guide member 61 has a guide base portion 63 attached to the board 15; and a light emitting device holding portion 67 connected to the guide base portion 63 by an elastic hinge 65. The light emitting device holding portion 67 has a structure that the light emitting device holding portion 67 pivots via the elastic hinge 65 to hold infrared light emitting devices 17. By this configuration, since the infrared light emitting devices 17 are held by using the light emitting device holding members 67, attachment work of the infrared light emitting devices 17 to the board is facilitated. In the above-described example, the board 15 is inverted to solder the infrared light emitting devices 17 to both sides of the board 15. In the present embodiment, dropping off of the devices upon inverting the board can be prevented, and thus, attachment work is facilitated.

A preferred embodiment of the present invention is described above. However, the present invention is not limited to the above-described embodiment and the above-described embodiment can, of course, be modified by those skilled in the art within the scope of the present invention.

Although the preferred embodiment of the present invention considered at the present time is described above, it is to be understood that a variety of modifications can be made to the embodiment, and all those modifications which fall within the true spirit and scope of the present invention are intended to be embraced in the appended claims.

### INDUSTRIAL APPLICABILITY

As described above, a wireless microphone according to the present invention has advantageous effects that the structure is simple and the number of components can be reduced and thus productivity can be improved. Thus, the wireless microphone is useful as a wireless microphone used at facilities such as convention centers, etc.

### DESCRIPTION OF REFERENCE NUMERALS

1 MIC
3 BODY CASE
5 INFRARED PASS-THROUGH COMPONENT
7 MIC NET COMPONENT
15 BOARD
17 INFRARED LIGHT EMITTING DEVICE
19 GUIDE MEMBER
31, 33, and 35 SUPPORT PORTION
41 REFLECTING WALL
51 VISIBLE LIGHT EMITTING DEVICE

1-9. (canceled)

10. A wireless microphone that transmits audio signals using infrared rays,
wherein a plurality of infrared light emitting devices are provided on each side of a board in the wireless microphone, and the infrared light emitting devices on both board surfaces are disposed radially,
further, a number of the infrared light emitting devices is set according to directivities of the infrared light emitting devices such that a radiation range covers all directions, and the plurality of infrared light emitting devices are disposed to be spaced from each other in a circumferential direction,
and wherein the wireless microphone comprises a reflecting wall between adjacent infrared light emitting devices, the reflecting wall reflecting infrared rays from the infrared light emitting devices on both sides.

11. The wireless microphone according to claim 10, wherein the infrared light emitting devices disposed on one side of the board and the infrared light emitting devices disposed on an other side are offset in a direction along the board surface.

12. The wireless microphone according to claim 10, wherein the infrared light emitting devices are attached so as to be inclined with respect to the board such that each infrared light emitting device is oriented to an elevation angle direction in a mic position taken when the mic is used.

13. The wireless microphone according to claim 10,
wherein a guide member is attached to each side of the board, and the infrared light emitting devices are attached to the board with the infrared light emitting devices disposed on their corresponding guide members, each guide member regulating positions and directions of corresponding infrared light emitting devices,
and wherein each of the guide members has a guide base portion attached to the board; and a light emitting device holding portion connected to the guide base portion by an elastic hinge, and the light emitting device holding portion has a structure that the light emitting device holding portion pivots via the elastic hinge to hold corresponding infrared light emitting devices.

14. The wireless microphone according to claim 13, wherein a visible light emitting device is disposed on the guide members, and the visible light emitting device emits visible light through an infrared pass-through member provided around the infrared light emitting devices.
